(19) United States
(12) Patent Application Publication
(10) Pub. No.: US 2012/0110562 A1
(43) Pub. Date: May 3, 2012

(54) SYNCHRONIZED FIRMWARE UPDATE

(76) Inventors: David Heinrich, Tomball, TX (US); Theodore F Emerson, Tomball, TX (US)

(21) Appl. No.: 12/913,486

(22) Filed: Oct. 27, 2010

(51) Int. Cl. G06F 9/44

(52) U.S. Cl. 717/169

(57) ABSTRACT

A first firmware image is copied from a first memory to a second memory. Firmware access requests are directed from a host processing system to a memory location in the second memory. A second firmware image is written to the first memory. Conditioned on occurrence of a switching event a switch is set to direct firmware access requests from the host processing system to a memory location in the first memory storing the second firmware image. In some cases, firmware access requests are directed from a host processing system to a memory location in a first memory storing a first firmware image. A second firmware image is written to a second memory. Conditioned on occurrence of a switching event, a switch is set to direct firmware access requests from the host processing system to a memory location in the second memory storing the second firmware image.

### BACKGROUND

Firmware includes machine-readable instructions or data structures that control or enable basic operational functionality of an electronic device. For example, a processor-based system (e.g., a computer) may include basic input/output system (BIOS) firmware that is used in a boot process that occurs each time the system is turned on or reset to initialize and configure the system. Examples of the types of components that BIOS firmware may include are system start-up routines, system configuration initialization information, disk boot routines, hardware interrupt handling instructions, and software program service request handling routines for interacting with I/O devices.

Firmware typically is implemented in a machine-language code that is stored as a binary image in a nonvolatile memory (e.g., a read-only memory (ROM) or a Flash nonvolatile random access memory (NVRAM). For various reasons, firmware may need to be updated with, for example, a new firmware version, a patch that corrects a bug, or an uncorrupted firmware version. This process may involve, for example, rebooting the system and overwriting (also referred to as “flashing”) the older firmware version that is in the nonvolatile memory with the updated firmware.

What are needed are improved systems and methods of updating firmware.

### DESCRIPTION OF DRAWINGS

FIG. 1 is a block diagram of an example of a computer system that includes a host processing system and a management controller.

FIG. 2 is a flow diagram of an example of a method that is performed by an example of the management controller of FIG. 1.

FIG. 3 is a block diagram of an example of the management controller of FIG. 1.

FIG. 4 is a flow diagram of an example of a method that is performed by an example of the management controller of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

A “processor” is any machine, device, or apparatus that processes data according to processor-readable instructions that are stored on a processor-readable medium either temporarily or permanently. An example of a processor is a computer. An “operating system” is a software component of a processor system that manages and coordinates the performance of tasks and the sharing of computing and hardware resources. A “software application” (also referred to as software, an application, computer software, a computer application, a program, and a computer program) is a set of instructions that a processor can interpret and execute to perform one or more specific tasks. A “data file” is a block of information that durably stores data for use by a software application.

Firmware includes machine-readable instructions or data structures that control or enable basic operational functionality of an electronic device. A firmware update includes, for example, a replacement of an existing firmware image, a new version of the existing firmware image, and a patch that corrects or otherwise fixes a bug or corruption in the existing firmware image.

A central processing unit (CPU) is an electronic circuit that can execute a software application. A CPU can include one or more processors (or processing cores). A “host CPU” (also referred to herein as a “host processing system”) is a CPU that controls or provides services for other devices, including I/O devices and other peripheral devices.

The term “processor” refers to an electronic circuit, usually on a single chip, which performs operations including but not limited to data processing operations, control operations, or both data processing operations and control operations.

An “embedded processing element” is a collection of one or more electronic circuits that is may be designed to be an integral component of a multiprocessing computer system. An embedded processing element may include one or more processors, host interface elements (e.g. I/O bus connections to the host computing system), memory interface controllers, integrated high-speed devices (e.g., graphics controllers), and on-chip integrated peripheral input/output (I/O) components (e.g., network interface controller, universal serial bus ports, flash memory, and audio devices). An embedded processing element may be designed to include one or more attached memory elements or peripheral components to allow it to function independently of its host computing system.

The term “processor-readable medium” refers to any tangible, non-transitory medium capable storing information that is readable by a machine (e.g., a computer). Storage devices suitable for tangibly embodying these instructions and data include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “memory location” is any type of data storage location of a processor-readable medium. Examples of memory locations include mapped memory locations and port mapped memory locations.

As used herein, the term “includes” means includes but not limited to, and the term “including” means including but not limited to. The term “based on” means based at least in part on.

The examples that are described herein provide systems and methods of updating host firmware (e.g., BIOS firmware) independently of the host processing system while ensuring that the host processing system can access a valid firmware image during the firmware update. In this way, these examples enable firmware to be updated automatically in a background process outside the scope of operating system operations without risk of operational failure of the host processing system that otherwise might occur if a valid firmware image were not available to the host processing system during the firmware update process. For example, when host firmware is being programmed or “flashed” onto a Flash memory device, neither the original firmware version nor the new firmware version is available to the host operating system until the update process completes. The examples described herein solve this problem by making a copy of the original firmware version available during the firmware update process. In addition, these examples provide a synchronized and seamless transitioning of the host firmware to the updated firmware in a way that avoids inadvertent switching between firmware versions during times when the host processing system is processing the prior firmware version. This feature prevents differences between the firmware images from adversely affecting the operation of the host processing system as a result of asynchronous events that are outside the scope of control of the updating process.

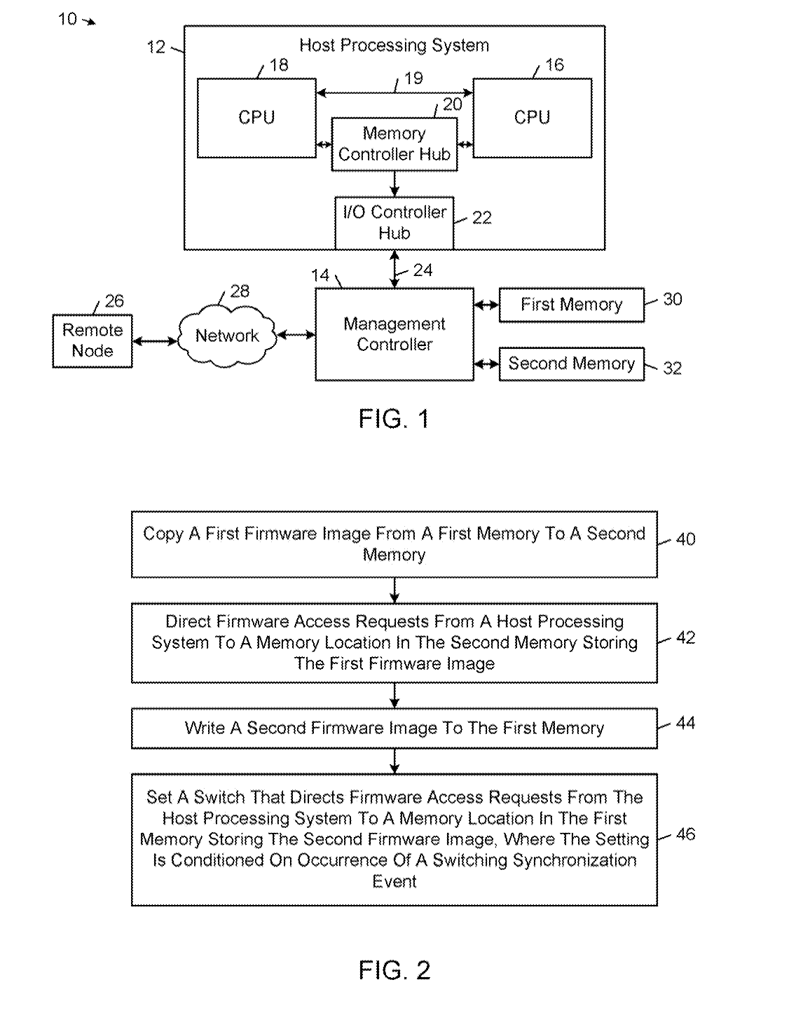

FIG. 1 shows an example of a computer system 10 that includes a host processing system 12 that is connected to a management controller 14. The host processing system 12 includes one or more processors 16, 18 that are connected by an interconnect link 19, a memory controller hub 20, and an I/O (Input/Output) controller hub 22. In some examples, the memory controller hub 20 and the I/O controller hub 22 are Intel® hub architecture components.

The management controller 14 is an embedded processing element that operates independently of the host processing system to perform system management and status operations of the computer system 10, such as manage environmental functions, manage log event data, manage sensor interfaces, and provide independent network access to the managed server. The management controller 14 typically includes hardware (e.g., an internal processor) and firmware components that implement this functionality. The management controller 14 communicates with the host interface 22 over a bus 24, which in some examples is a Low Pin Count (LPC) bus and/or a Peripheral Component Interconnect Express (PCIE) bus.

In some examples, the management controller 14 also serves as a baseboard management controller (BMC) of the computer system 10 that performs many different system management functions. For example, the management controller 14 may comply with the Intelligent Platform Management Interface (IPMI) (see e.g., “IPMI: Intelligent Platform Management Interface Specification, Second Generation,” v.2.0, Feb. 12, 2004), which defines a standard interface between the management controller 14 and the computer system 10. Additional standards and protocols may be supported by the management controller 14. The management controller 14 operates independently of the host processing system, the BIOS, and the operating system. The management controller 14 also is powered independently of the host processing system 12 and other components of the computer system 10 so that the management controller 14 remains functional when the computer system is turned off.

The management controller 14 typically is connected to a remote monitoring node 26 over a network 28 (e.g., a LAN or a WAN). The remote node 24 can use the management controller 14 to remotely monitor and control the operation of the computer system 10. The management controller 14 may also provide hardware functions necessary for the host processing system 12 to operate. One of those functions is to provide the host processing system 12 with its firmware instructions.

In the example illustrated in FIG. 1, the management controller 14 includes a memory interface through which it manages transactions with a first memory 30 and a second memory 32. The first memory 30 typically is Flash or other non-volatile storage repository. The second memory 32 typically is DRAM (e.g., DDR2 or DDR3), offering bulk storage, fast access, and infinite write capability at the expense of volatility. In other examples, one or both of the memories 30, 32 reside within the management controller 14.

As explained in detail below, the first memory 30 stores a firmware image (e.g., a BIOS image) that includes machine-readable instructions and/or data structures that control or enable basic operational functionality of the host processing system 12. The second memory 32 is used to provide a secondary firmware repository used in conjunction with the first memory 30 to enable a synchronized, operating system independent firmware update. The firmware update image may be, for example, a new firmware version, a replacement of the existing firmware version, or a firmware patch for the existing firmware version. The firmware update image may be obtained from a wide variety of different sources, including the remote monitoring node 26, a portable memory (e.g., a secure digital (SD) nonvolatile memory card) coupled to the memory interface of the management controller 14, an internal memory of the management controller 14, and the second memory 32.

FIG. 2 shows an example of a method that is performed by an example of the management controller 14 in transitioning of the host processing system 12 from the firmware image stored in the first memory 30 to a firmware update image.

In accordance with the method of FIG. 2, the management controller 14 copies a first firmware image from the first memory 30 to the second memory 32 (FIG. 2, block 40). After copying the first firmware image, the management controller 14 directs firmware access requests from the host processing system 12 to a memory location in the second memory 32 storing the first firmware image (FIG. 2, block 42). After copying the first firmware image, the management controller 14 also writes a second firmware image to the first memory 30 (FIG. 2, block 44). After writing the second firmware image, the management controller 14 sets a switch that directs firmware access requests from the host processing system 12 to a memory location in the first memory 30 storing the second firmware image, where the setting is conditioned on occurrence of a switching synchronization event (FIG. 2, block 46). The switch may be any type of component or mechanism that is responsive to the synchronization event and is capable of changing the state of the routing mechanism that routes the firmware access requests from the host processing system 12 between the first memory 30 and the second memory 32. The switch may be implemented in one or a combination of software, firmware, or hardware.

The writing of the first and second firmware images to memory typically involves testing and verifying that the firmware images have been written correctly.

In some examples, the copying of the first firmware image (FIG. 2, block 40) is performed in response to receipt of a command from the remote monitoring node 26 to update the firmware with a firmware update image (e.g., a new firmware version, a replacement of the existing firmware version, or a patch for the existing firmware version) that is available from a specified source (e.g., a remote network node). In these examples, the management controller 14 retrieves a copy of the firmware update image from the specified source, either directly or through a network connection 28, and stores the retrieved copy of the firmware update image in the second memory 32 (FIG. 2, block 44).

In some examples, the directing of firmware access requests from the host processing system 12 to a memory location in the second memory 32 storing the first firmware image is achieved by a firmware write to a control register that re-routes the firmware access requests from the first memory 30 to the second memory 32. The effect of this control register to re-route the firmware access requests may be conditioned on occurrence of a synchronization event relating to transaction activity on a bus (e.g., the LPC bus) over which the firmware access requests are received from the host processing system 12. For example, in some cases, the directing is conditioned on detection of a signal indicating that the bus 24 is idle. This bus-level synchronization avoids problems associated with copying memory locations in the first memory 30 that may be the subject of ongoing firmware access requests or processing by the host processing system 12.

In some examples, the setting of the switch (FIG. 2, block 46) is conditioned on occurrence of a synchronization event during which the host processing system is unable to issue a firmware access request. For example, in some cases, the setting is conditioned on the host processing system 12 being unable to access the first memory 30, such as when the host processing system 12 is being reset. This firmware image level of synchronization avoids problems associated with switching the host processing system to the firmware update image while the host processing system currently is performing operations based on the prior firmware image because the host processing system 12 cannot be performing such operations if it is being reset. In this way, the management controller 14 can provide a seamless transition of the host processing system 12 to the firmware update image 62.

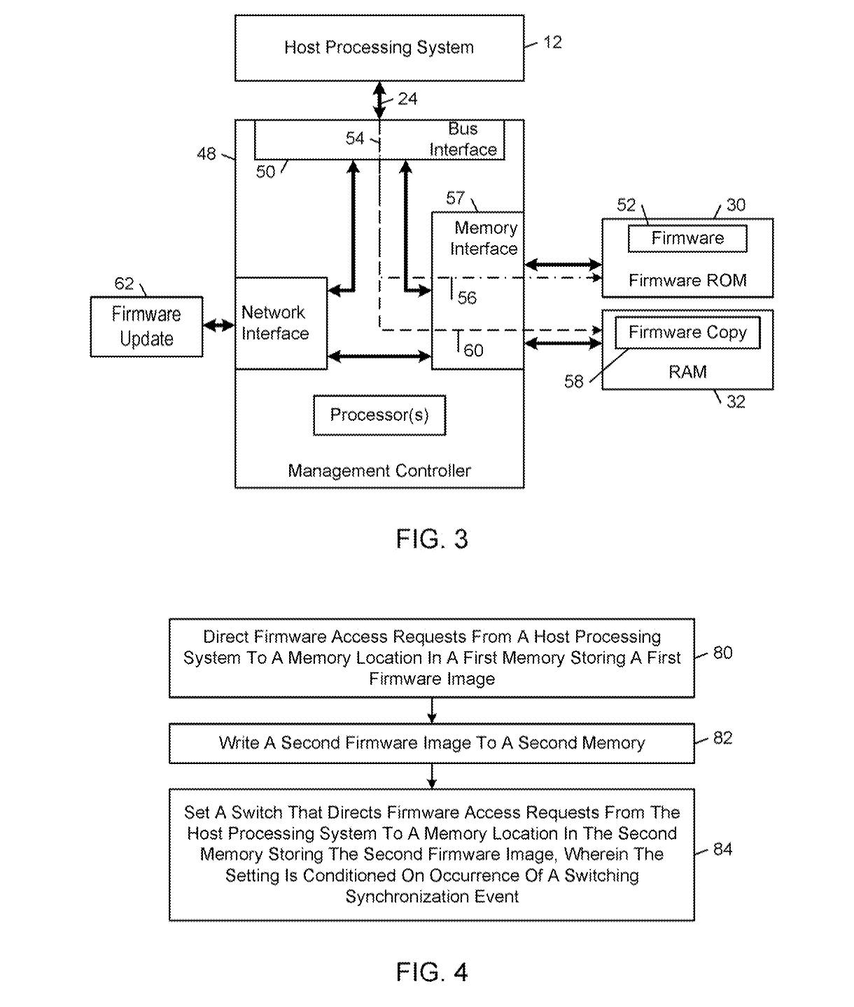

Referring to FIG. 3, an implementation 48 of the management controller 14 includes a bus interface 50 that responds to bus transactions 54 requesting access to a memory address range in the first memory 30 that is associated with accesses to an existing firmware image 52 that is stored in the first memory 30. Under normal operating conditions, logic in the management controller 48 decodes these bus transactions 54 into memory access requests 56 that reference the memory addresses in the first memory 30 that are specified in the bus transactions 54. The bus interface 54 passes the memory access requests 56 to a memory interface 57 that translates the memory access requests into memory transactions that are addressed to the memory addresses in the first memory 30 that are specified in the bus transactions 54. After a firmware copy 58 of the first firmware image 52 has been stored in the second memory 32, the firmware of the management controller 48 sets a switch to decode subsequent access request bus transactions 54 into memory access requests 60 that reference memory addresses in the second memory 32 storing the portions of the firmware copy that correspond to the portions of the original firmware 52 that are specified in the bus transactions 54. After a firmware update image has been written to the first memory 30, the management controller 48 creates a deferred switch that is set based on occurrence of a switching synchronization event (e.g., reset of the platform, including the host processing system 12). After the synchronization event, logic in the management controller 48 decodes subsequent bus transactions 54 into memory access requests 56 that reference the memory addresses in the first memory 30 that are specified in the bus transactions 54 and correspond to the storage locations of the updated firmware image.

In one example of the computer system 10, the management controller 14 serves as a BMC of the computer system 10, the first memory 30 is implemented by a Flash memory that stores system ROM (SROM), and the second memory 32 is implemented by a dynamic random access memory (DRAM). The management controller 14 includes a first register (referred to herein as the “SROM Next Size Register”) and a second register (referred to herein as the “SROM RAM Offset Register”) with register fields that are defined below in Table 1 and Table 2, respectively. The “SROM Next Size Register” is a next state (or staging) register and the SROM RAM Offset Register is a current state register. The “SROM Next Size Register” contains settings that are applied to the SROM RAM Offset Register when a synchronization event (e.g., a reset of the host processing system 12) occurs.

In this example, the management controller 14 performs an update (e.g., a BIOS update) of an existing firmware image stored in the SROM as follows. First, the management controller 14 creates a copy of the existing firmware image in the DRAM. The management controller 14 sets the SROM Offset into RAM field in the SROM RAM Offset Register to an offset value that points to the location of the copy of the existing firmware image in the DRAM. The management controller 14 sets the SROM RAM Enable bit in the SROM RAM Offset Register to 1, which causes all host processing system access requests to the existing firmware stored in the SROM to be redirected to the firmware copy stored in the DRAM. To prevent the transition from occurring in the middle of an outstanding firmware bus cycle, the SROM RAM Enable bit is further conditioned to take effect only when the bus 24 is idle. The management controller 14 then updates the existing firmware stored in the SROM, as described above. After the firmware image stored in the SROM has been updated, the management controller 14 populates the Next SROM Size field in the SROM Next Size Register with the size of the updated firmware image in the SROM. The management controller 14 clears the Next SROM RAM Enable bit in the SROM RAM Offset Register to 0, which will cause all host processing system firmware access requests to be directed to the updated firmware image stored in the SROM after the next reset of the host processing system 12. To allow the “Next” Size and SROM RAM Enable values to be loaded into the SROM RAM Offset Register when the next reset occurs, the management controller 14 sets the Next Size Load Enable bit in the SROM Next Size Register to a 1. After the next reset, the contents of the Next SROM RAM Enable field and the Next SROM Size field of in the SROM Next Size Register will be loaded into the SROM Size field in the SROM RAM Offset Register, which causes all host processing system firmware access requests automatically to be forwarded to the updated firmware image stored in the SROM.

TABLE 1
8-Bit SROM Next Size Register

| Bit | Description |
|---|---|
| Next | When this bit is set, the contents of this register |
| Size | will be loaded into the contents of the SROM Size |
| Load | Register when a reset occurs. |
| Enable | Specifically, the “Next SROM RAM Enable” will be |
| | copied to the “SROM RAM Enable” bit of the SROM |
| | Size Register and the “Next ROM Size” field will be |
| | copied to the “SROM Size” field of the SROM Size |
| | Register. This bit will automatically clear when the |
| | contents of this register are successfully |
| | transferred to the SROM size register. |
| Next | When this bit is set, accesses from the bus 24 will |
| SROM | be mapped to the second memory 32 and not to the |
| RAM | first memory 30 following a reset event. Similarly, |
| Enable | when clear, accesses from the bus 24 will be mapped |
| | to the first memory 30 and not the second memory 32 |
| | following a reset event. The size field should be |
| | modified at the same time by firmware to ensure |
| | synchronization between the mapped device and the |
| | allowed block size. |
| Next | These bits set the memory window size that firmware |
| SROM | image is allowed into its mapped device (e.g., the |
| Size | first memory 30 or the second memory 32) following a |
| | reset event. |

TABLE 2
32-Bit SROM RAM Offset Register

| Bit | Description |
|---|---|
| SROM | This field specifies the offset into the second |
| Offset | memory 32. These bits must be consistent with the |
| into | SROM Size field for proper address translation. |
| RAM | |
| SROM | When this bit is set, a firmware image write from |
| RAM | bus 24 will be ignored hence protecting the firmware |
| Write | image in the second memory. |
| Protect | |
| Enable | |
| SROM | When this bit is set, system ROM firmware accesses |
| RAM | from the bus 24 will be mapped to the second memory |
| Enable | and not to the first memory 30. Similarly when |
| | clear, system ROM firmware accesses from the bus 24 |
| | will be mapped to the first memory 30 and not the |
| | second memory 32. The setting of this field and the |
| | “SROM Size” field are conditioned to only take |
| | effect when the bus 24 is IDLE to prevent a |
| | transition from occurring in the middle of an |
| | outstanding firmware access. The size field should |
| | be modified at the same time by firmware to ensure |
| | synchronization between the mapped device and the |
| | allowed block size. |
| SROM | These bits set the memory window size that a |
| Size | firmware image is allowed into its mapped device |
| | (e.g., the first memory 30 or the second memory 32). |
| | The SROM size field and the “SROM RAM Enable” field |
| | are conditioned to only take effect when the bus 24 |
| | is IDLE to prevent a transition from occurring in |
| | the middle of an outstanding firmware access. |

FIG. 4 shows an example of a method that is performed by an example of the management controller 14 in transitioning of the host processing system 12 from a first firmware image stored in the first memory 30 to a second firmware image stored in the second memory 32.

In accordance with this method, the management controller 14 directs firmware access requests from the host processing system 12 to a memory location in the first memory 30 storing a first firmware image (FIG. 4, block 80). The management controller 14 writes a second firmware image to the second memory 32 (FIG. 4, block 82). After writing the second firmware image to the second memory 32, the management controller 14 sets a switch that directs firmware access requests from the host processing system to a memory location in the second memory 32 storing the second firmware image, where the setting is conditioned on occurrence of a switching synchronization event (FIG. 4, block 84).

Some examples of the method of FIG. 4 are performed each time the host processing system 12 is being booted. In these examples, the first memory 30 stores a first BIOS firmware image that the host processing system 12 executes in an initial boot process. During the initial boot process, the host processing system 12 is placed on-hold while the management controller 14 retrieves a second BIOS firmware image, stores the second BIOS image in the second memory 32, and sets the switch for deferred redirecting BIOS firmware access requests from the host processing system 12 from the first memory 30 to the second memory 32. The management controller 14 then initiates a reset of the host processing system 12. The reset operation triggers the switch that causes BIOS firmware access requests from the host processing system 12 to be directed to the second memory 32, which contains the full BIOS firmware image. In these examples, the first BIOS image may be a placebo or standby firmware image that includes a minimal set of BIOS instructions and metadata that provide the basic functionality needed to boot the computer system 10 and trigger the management controller 14 to perform the changeover to a full versioned BIOS firmware that enables the host processing system 12 to perform a complete boot process. In this way, the first memory 30 may be implemented by a relative small and inexpensive memory that only has to store the placebo or standby firmware image, thereby reducing the cost of manufacturing the computer system 10. The full BIOS firmware image may be retrieved by the management controller 14 from the remote monitoring node 26.

In some of these examples, after initiating the reset of the host processing system 14, the management controller 14 resets the switch to direct BIOS firmware access requests from the host processing system 12 to the first memory 30 conditioned on a subsequent reset of the host processing system 12. In this way, the next time the host processing system is reset, it initially will boot from the first BIOS image stored in the first memory 30 before being redirected by the management controller 14 to the second BIOS image stored in the second memory 32 in accordance with the method of FIG. 4.

Other embodiments are within the scope of the claims.

1. A method, comprising:
copying a first firmware image from a first memory to a second memory;
after the copying, directing firmware access requests from a host processing system to a memory location in the second memory storing the first firmware image;
after the copying, writing a second firmware image to the first memory;
after the writing, setting a switch that directs firmware access requests from the host processing system to a memory location in the first memory storing the second firmware image, wherein the setting is conditioned on occurrence of a switching synchronization event.

2. The method of claim 1, wherein the directing of firmware access'requests from the host processing system to the memory location in the second memory storing the first firmware image is conditioned on occurrence of a synchronization event relating to transaction activity on a bus over which the firmware access requests are received from the host processing system.

3. The method of claim 2, wherein the directing is conditioned on detection of a signal indicating that the bus is idle.

4. The method of claim 1, wherein the setting is conditioned on occurrence of a synchronization event during which the host processing system is unable to issue a firmware access request.

5. The method of claim 4, wherein the setting is conditioned on the host processing system being reset.

6. The method of claim 1, before the writing, copying the second firmware image from a third memory.

7. The method of claim 1, wherein the first and second firmware images are different respective basic input/output system (BIOS) images.

8. A method, comprising:
directing firmware access requests from a host processing system to a memory location in a first memory storing a first firmware image;
writing a second firmware image to a second memory;
after the writing, setting a switch that directs firmware access requests from the host processing system to a memory location in the second memory storing the second firmware image, wherein the setting is conditioned on occurrence of a switching synchronization event.

9. The method of claim 8, wherein the setting is conditioned on occurrence of a synchronization event during which the host processing system is unable to issue a firmware access request.

10. The method of claim 9, wherein the setting is conditioned on the host processing system being in an operating state in which the host processing system cannot access the first memory.

11. The method of claim 8, wherein the first and second firmware images are different respective basic input/output system (BIOS) images.

12. Apparatus, comprising:
a host processing system; and
a management controller coupled to the host processing system and operable to perform operations comprising
copying a first firmware image from a first memory to a second memory;
after the copying, directing firmware access requests from the host processing system to a memory location in the second memory storing the first firmware image;
after the copying, writing a second firmware image to the first memory;
after the writing, setting a switch that directs firmware access requests from the host processing system to a memory location in the first memory storing the second firmware image, wherein the setting is conditioned on occurrence of a switching synchronization event.

13. The apparatus of claim 12, wherein the directing of firmware access requests from the host processing system to the memory location in the second memory storing the first firmware image is conditioned on occurrence of a synchronization event relating to transaction activity on a bus over which the firmware access requests are received from the host processing system.

14. The apparatus of claim 12, wherein the setting is conditioned on occurrence of a synchronization event during which the host processing system is unable to issue a firmware access request.

15. The apparatus of claim 12, wherein the first and second firmware images are different respective basic input/output system (BIOS) images.

16. The apparatus of claim 12, wherein the management controller serves as a baseboard management controller.

17. The apparatus of claim 12, further comprising a next state register and a current state register, wherein in the setting the management controller performs operations comprising writing bits to the next state register that map firmware access requests from the host processing system to the memory location in the first memory storing the second firmware image, and the bits written to the next state register are applied to the current state register upon occurrence of the switching synchronization event.

18. Apparatus, comprising:
a host processing system; and
a management controller coupled to the host processing system and operable to perform operations comprising
directing firmware access requests from the host processing system to a memory location in a first memory storing a first firmware image;
writing a second firmware image to a second memory;
after the writing, setting a switch that directs firmware access requests from the host processing system to a memory location in the second memory storing the second firmware image, wherein the setting is conditioned on occurrence of a switching synchronization event.

19. The apparatus of claim 18, wherein the setting is conditioned on occurrence of a synchronization event during which the host processing system is unable to issue a firmware access request.

20. The apparatus of claim 18, wherein the first and second firmware images are different respective basic input/output system (BIOS) images.
